(19) United States
(12) Patent Application Publication
(10) Pub. No.: US 2019/0034727 A1
(43) Pub. Date: Jan. 31, 2019

(54) Picking Robot and Picking System

(71) Applicant: Hitachi Transport System, Ltd., Tokyo (JP)

(72) Inventors: Nobuhiro CHIHARA, Tokyo (JP); Nobutaka KIMURA, Tokyo (JP); Yasuki SHIMAZU, Tokyo (JP)

(21) Appl. No.: 16/033,954

(22) Filed: Jul. 12, 2018

(30) Foreign Application Priority Data
Jul. 27, 2017 (JP) 2017-145527

(51) Int. Cl. G06K 9/00; G06T 7/73; B25J 9/16

(52) U.S. Cl. CPC G06K 9/00664; B25J 9/1664; B25J 9/1697; G06T 7/73

(57) ABSTRACT

A picking robot executes an acquisition process for acquiring the latest recognition result from a storage destination of the latest recognition result of a housed area on the basis of the latest imaged image of the housed area, a modification process for accessing the housed area and modifying a location in the housed area by controlling the robot arm on the basis of the latest recognition result acquired in the acquisition process, an imaging process for imaging the housed area after modification in the housed area by the modification process by controlling the imaging device, a recognition process for recognizing residual articles in the housed area on the basis of an image imaged in the imaging process, and a transmission process for transmitting the recognition result in the recognition process to the storage destination.

### CLAIM OF PRIORITY

The present application claims priority from Japanese patent application JP 2017-145527 filed on Jul. 27, 2017, the content of which is hereby incorporated by reference into this application.

### BACKGROUND

The present invention relates to a picking robot and a picking system respectively for extracting or housing an article.

In an automated warehouse, work for imaging an article with an arm robot after an automated guided vehicle (AGV) for carrying a shelf reaches and stops, inserting fingers among the shelves after a recognition process and extracting the article is performed. JP 2016-206066 A discloses an object recognition device that executes the abovementioned recognition process of an article.

This object recognition device is provided with storage means that stores an object category of each region set in working environment of a robot, identification information of an object which belongs to the object category and contour information of the object in a state in which they are correlated, distance information acquiring means that acquires distance information of the object to be recognized, region specifying means that specifies the region in which the object exists, candidate detecting means that detects objects in the region as an object candidate on the basis of the distance information of the object acquired by the distance information acquiring means and recognition means that recognizes the object candidate detected by the candidate detecting means by comparing the object candidate with the contour information of the object which belongs to the object category of the region specified by the region specifying means using information stored by the storage means.

However, in-warehouse work has a problem that as recognition processing time of a target article is included in stand-by time till extraction or housing in work for extracting or housing the target article after recognition of the target article, it takes time until extracting or housing the target article is completed.

### SUMMARY

An object of the present invention is to reduce operation time in in-warehouse work.

A picking robot which is one aspect of the present invention disclosed in this application is on the basis of a picking robot provided with a processor that executes a program, a storage device that stores the program, an imaging device that images an object and a robot arm that extracts an article from a housed area of the article, and has a characteristic that the processor executes an acquisition process for acquiring the latest recognition result from a storage destination of the latest recognition result of the housed area on the basis of the latest imaged image of the housed area, an extraction process for extracting the article from the housed area by controlling the robot arm on the basis of the latest recognition result acquired in the acquisition process, an imaging process for imaging the housed area after extracting the article in the extraction process by controlling the imaging device, a recognition process for recognizing residual articles in the housed area on the basis of an image imaged in the imaging process, and a transmission process for transmitting a recognition result in the recognition process to the storage destination.

In addition, a picking robot which is another aspect of the present invention disclosed in this application is on the basis of a picking robot provided with a processor that executes a program, a storage device that stores the program, an imaging device that images an object, and a robot arm that houses an article in a housed area, and has a characteristic that the processor executes an acquisition process for acquiring the latest recognition result from a storage destination of the latest recognition result of the housed area on the basis of the latest imaged image of the housed area, a housing process for housing the article in the housed area by controlling the robot arm on the basis of the latest recognition result acquired in the acquisition process, an imaging process for imaging the housed area after housing the article in the housing process by controlling the imaging device, a recognition process for recognizing residual articles in the housed area on the basis of the image imaged in the imaging process, and a transmission process for transmitting the recognition result in the recognition process to the storage destination.

### Advantageous Effects of Invention

According to representative embodiments of the present invention, operation time in in-warehouse work can be reduced. Problems, configurations and effects except the abovementioned ones will be clarified by the description of the following embodiments.

### BRIEF DESCRIPTION OF THE DRAWINGS

FIG. 1 is a table showing relation between in-warehouse work and robot arm operation of a picking robot.

FIG. 2 is a schematic diagram showing a shipping work example 1 in a first embodiment.

FIG. 3 is an illustration showing a transmission example 1 of a recognition result.

FIG. 4 is an illustration showing a transmission example 2 of a recognition result.

FIG. 5 is a block diagram show a hardware configuration example of the picking robot.

FIG. 6 is a flowchart showing a detailed picking procedure example 1 of the picking robot in the first embodiment.

FIG. 7 is a flowchart showing a detailed picking procedure example 2 of the picking robot in the first embodiment.

FIG. 8 is a schematic diagram showing a shipping work example 2 in the first embodiment.

FIG. 9 is a flowchart showing a detailed picking procedure example 3 of the picking robot in the first embodiment.

FIG. 10 is a flowchart showing a detailed picking procedure example 4 of the picking robot in the first embodiment.

FIG. 11 is a schematic diagram showing a warehousing work example 1 in a second embodiment.

FIG. 12 is a flowchart showing a detailed housing procedure example 1 of the picking robot in the first embodiment.

FIG. 13 is a flowchart showing a detailed housing procedure example 2 of a picking robot in the second embodiment.

FIG. 14 is a schematic diagram showing a warehousing work example 2 in the second embodiment.

FIG. 15 is a flowchart showing a detailed housing procedure example 3 of the picking robot in the first embodiment.

FIG. 16 is a flowchart showing a detailed housing procedure example 4 of the picking robot in the second embodiment.

### DETAILED DESCRIPTION OF THE EMBODIMENT

In the following embodiments, a picking system where a shelf is carried to a working station by an automated guided vehicle and a picking robot installed in the working station ships an article stored on the shelf or stores a carried-in article may also be adopted, and a picking system where a picking robot is moved to a position of a shelf by automated traveling and ships an article stored on the shelf or stores a carried-in article is stored may also be adopted. The picking robot is a double arm robot equipped with a 3D camera for example.

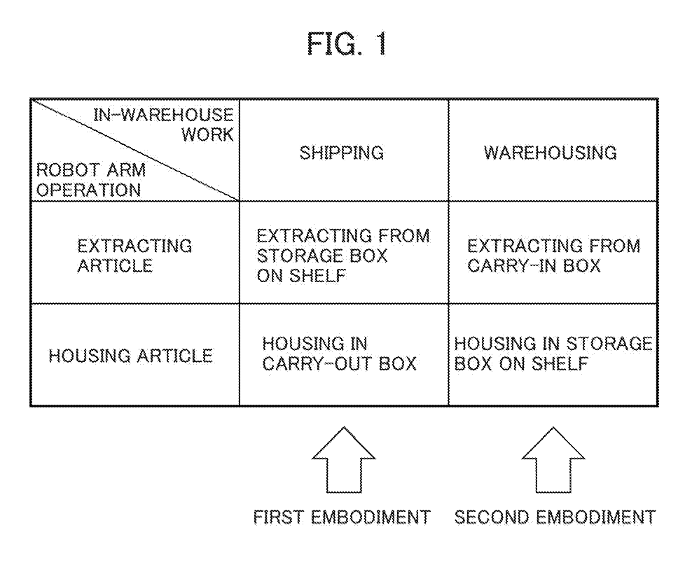

FIG. 1 is a table showing relation between in-warehouse work and robot arm operation of a picking robot. When the in-warehouse work is shipping, robot arm operation for extracting an article is equivalent to operation for extracting an article from a housing which is stored on a shelf and which is one example of a housing region, and robot arm operation for housing an article is equivalent to operation for housing an article extracted from the housing in a carry-out box. Prior to the robot arm operation, picking information including an article to be extracted and its storage location is provided to the picking robot beforehand.

When the in-warehouse work is warehousing, robot arm operation for extracting an article is equivalent to operation for extracting an article from a carry-in box 215 and robot arm operation for housing the article is equivalent to operation for housing the article extracted from the carry-in box 215 in a housing on a shelf. Prior to the robot arm operation, housing information including an article to be housed and its storage destination is provided to the picking robot beforehand. An example that the in-warehouse work is shipping will be described as a first embodiment and an example that the in-warehouse work is warehousing will be described as a second embodiment.

### First Embodiment

<Shipping Work Example 1>

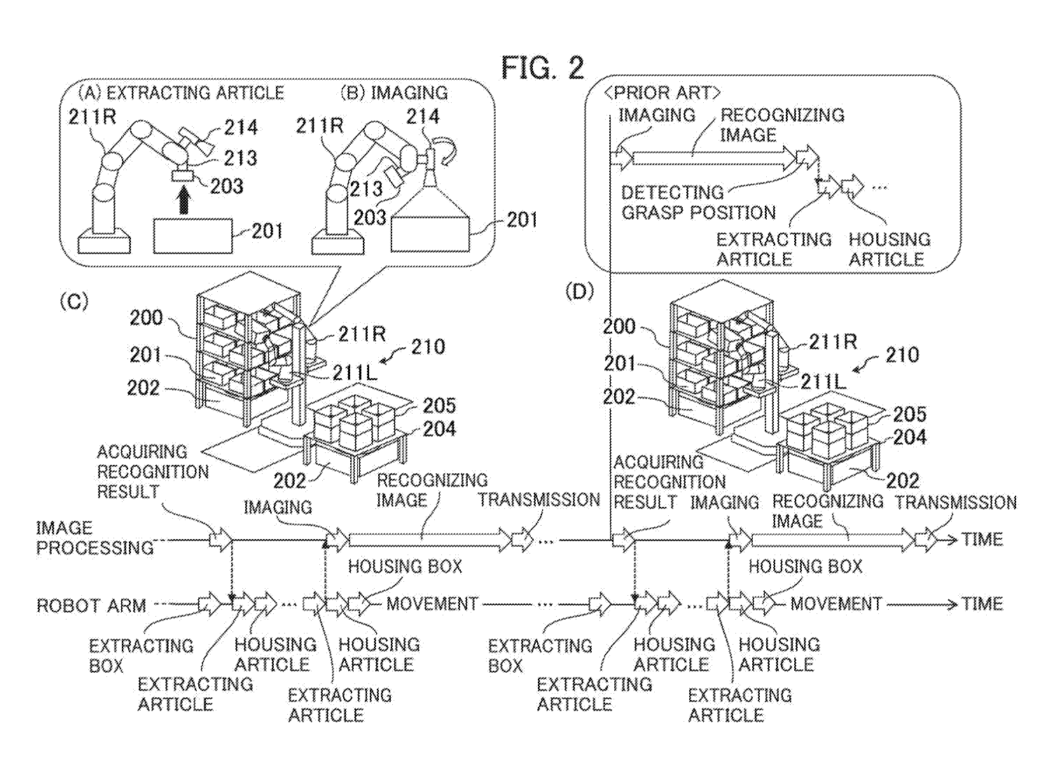

FIG. 2 is a schematic diagram showing a shipping work example 1 in a first embodiment. One or more housings 201 are stored on a shelf 200. One or more articles 203 are housed in a housing 201. In one housing 201, one or more types of articles 203 are stored. The shelf 200 and a workbench 204 are carried by an automated guided vehicle 202 for example.

A picking robot 210 is a double arm robot, extracts the housing 201 from the shelf 200 with one robot arm, for example, a left robot arm 211L, holding the housing, and extracts the article 203 from the housing 201 with the other robot arm, for example, a right robot arm 211R.

Each robot arm 211 is a multi-shaft type articulated arm and is provided with a hand 213 at its end. A driving shaft for each joint of the robot arm 211 is controlled by a processor in the picking robot 210. The right robot arm 211R separately extracts the article 203 from the housing 201 and houses it in a carry-out box 205 on the workbench 204.

Concretely, for example, the right robot arm 211R is provided with a 3D camera 214 at its end. (A) After the right robot arm 211R extracts the article 203 in extracting the article, (B) the right robot arm 211R images the housing 201 from its opening in a state in which a lens of the 3D camera 214 is directed to the opening of the housing 201, holding the article 203 with the hand 213.

In addition, each robot arm 211 is provided with a six-axis force sensor (not shown) between its end and the hand 213. The force sensor detects an overload applied to the hand 213. When an overload due to interference (collision or a touch) between the hand 213 or the article 203 grasped by the hand 213 and a wall of the housing 201 or another article 203 is detected while the robot arm extracts the article 203 loaded in bulk from the housing 201, the processor controls the driving shafts of the robot arm 211 so as to relieve the detected overload.

Moreover, the force sensor detects force that acts on the hand 213. Hereby, as weight of the article 203 acts on the hand 213 when the hand 213 grasps the article 203, the processor judges that the hand 213 grasps the article 203 if a value detected by the force sensor exceeds a predetermined threshold after picking operation of the article 203 is executed. As to a grasp of the article 203 by the hand 213, in addition to the force sensor, a tactile sensor may also be used. In addition, the grasp of the article 203 by the hand 213 can also be judged on the basis of an image imaged by the 3D camera 214.

Further, when the hand 213 is a suction type hand, the grasp of the article 203 by the hand 213 may also be judged on the basis of a measurement result of its pressure gage. The hand 213 can have various configurations if only the hand can hold the article 203. For example, the hand 213 may also grasp the article 203 by opening and closing plural fingers and may also grasp by attracting the article 203.

A process of the picking robot 210 will be described on a time base with the process separated into image processing by the processor and robot arm operation below. As shown in FIG. 2(C), first, when the processor accepts a picking request, the left robot arm 211L extracts the housing 201 from the shelf 200. The picking request includes identification information of merchandise to be picked, a picked number, identification information of a stored shelf and identification information of the housed housing 201.

Concretely, for example, the processor instructs the left robot arm 211L to extract the housing 201 from the shelf 200 by specifying a grasp position on the basis of a stored position of the housing 201 on the shelf 200 and a side of the housing 201 opposite to the picking robot 210, calculating an orbit from an initial position of the left robot arm 211L to the grasp position and controlling the driving shaft of each joint of the left robot arm 211L so as to enable reaching the orbit.

The processor acquires a recognition result of the image opposite to the opening of the housing 201 from a storage destination of the recognition result in an imaging process. The recognition result is a recognition result processed before this extraction of the housing 201. Owing to the recognition result, the processor can recognize that some article 203 is stored in some position of the housing 201. The storage destination means a radio frequency identifier (RFID) tag which is one example of a communicable record medium attached to the shelf 200 and a server communicable with the picking robot 210 for example.

When the processor acquires the recognition result, the right robot arm 211R extracts one article 203 from the housing 201 using the recognition result (extracting article) and houses the article in the carry-out box 205 (housing article). Concretely, for example, the processor instructs the right robot arm 211R to extract the article 203 from the housing 201 and to return to an initial position by specifying a grasp position of the article 203 to be picked on the basis of the recognition result, calculating an orbit from the initial position of the right robot arm 211R to the grasp position and controlling the driving shaft of each joint of the right robot arm 211R so as to enable reaching the orbit. The processor instructs the right robot arm 211R to house the grasping article 203 in the carry-out box 205 by specifying a position of the carry-out box 205, calculating an orbit from the initial position of the right robot arm 211R to the position of the carry-out box 205 and controlling the driving shaft of each joint of the right robot arm 211R so as to enable reaching the orbit.

The right robot arm 211R repeatedly executes the extraction of the article and the housing of the article by a number of articles specified in the picking request. When the right robot arm 211R extracts the article 203 last specified out of the number of the articles from the housing 201, contents of the corresponding housing 201, that is, residual articles 203 and their arrangement are unchanged until picking according to the next picking request or housing according to a housing request is performed.

Accordingly, in image processing, the processor instructs the 3D camera 214 to image opposite to the opening of the housing 201 as shown in (B), executes a recognition process of an imaged image, and transmits a recognition result to the storage destination. As for the recognition process, concretely, a well-known recognition process may also be used and for example, the processor stores a contour and texture of the article 203 and character information such as an article name, and recognizes the article 203 and its installation location by matching with the imaged image.

In addition, the right robot arm 211R houses the extracted article 203 in the carry-out box 205 and the left robot arm 211L houses the housing 201 on the shelf 200. Afterward, the picking robot 210 moves to another location, executing image recognition. Afterward, as shown in (D) in FIG. 2, when a processor of another picking robot 210 accepts a picking request for the same housing 201 on the same shelf 200 as that in (C), the left robot arm 211L extracts the housing 201 from the shelf 200 and the processor acquires the recognition result acquired in the image recognition in (C) from the storage destination of the recognition result. The following processing is similar to that in (C).

As described above, as the recognition result in the last picking or housing is read and the article 203 in the housing 201 and its position are detected when the picking robot 210 picks the article, the execution of image recognition before this article extraction by picking is not required and work efficiency can be enhanced.

### <Transmission Example of Recognition Result>

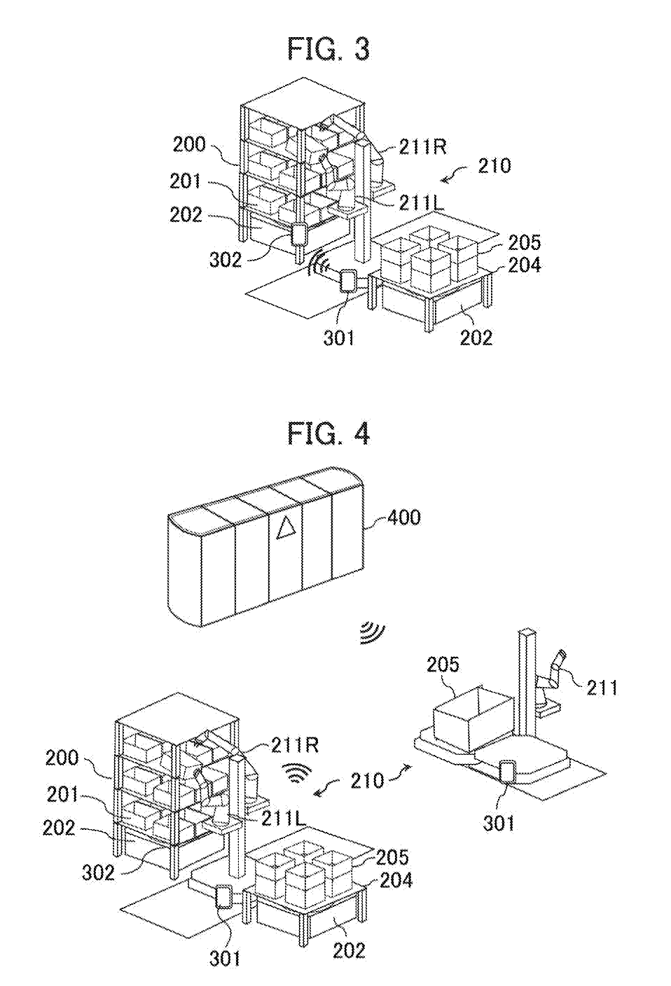

FIG. 3 is an illustration showing a transmission example 1 of a recognition result. As shown in FIG. 3, the, picking robot 210 is provided with a communication device 301 and the shelf 200 is provided with an RFID tag 302 which is a storage destination of the recognition result. Hereby, in (C) in FIG. 2, the picking robot 210 transmits a recognition result of an image opposite to the opening of the housing 201 to the RFID tag 302 and the RFID tag 302 holds the received recognition result. In addition, in (D) in FIG. 2, the picking robot 210 receives the recognition result from the RFID tag 302. The RFID tag 302 overwrites the recognition result every the housing 201 to avoid capacity shortage.

FIG. 4 is an illustration showing a transmission example 2 of a recognition result. As shown in FIG. 4, the picking robot 210 is provided with a communication device 301 and the communication device can communicate with the server 400 which is a storage destination of the recognition result. Hereby, in (C) in FIG. 2, the picking robot 210 transmits a recognition result of an image opposite to the opening of the housing 201 to the server 400 and the server 400 holds the received recognition result. In addition, in (D) in FIG. 2, the picking robot 210 receives the recognition result from the server. In place of the picking robot 210, the server 400 may also execute a recognition process. In this case, the picking robot 210 transmits an image imaged opposite to the opening of the housing 201 to the server 400, the server 400 recognizes the article 203 and its position on the basis of the received imaged image, and the server stores a result of the recognition.

### <Hardware Configuration Example of Picking Robot 210>

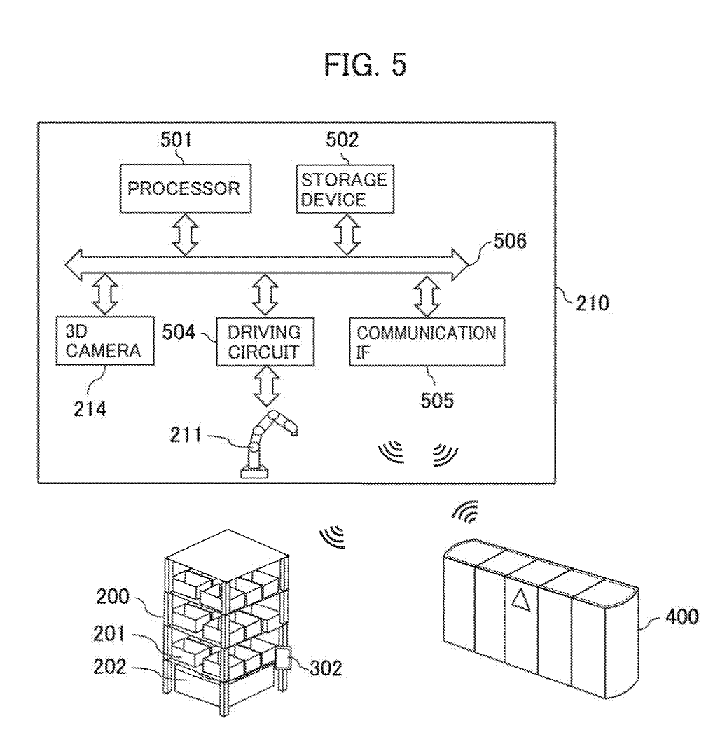

FIG. 5 is a block diagram showing a hardware configuration example of the picking robot 210. The picking robot 210 is provided with the processor 501, a storage device 502, the 3D camera 214, a driving circuit 504, and a communication interface (IF) 505. The processor 501, the storage device 502, the 3D camera 214, the driving circuit 504, and the communication IF 505 are connected via a bus 506. The processor 501 controls the picking robot 210. The storage device 502 functions as a work area of the processor 501. In addition, the storage device 502 is a non-temporary or temporary record medium that stores various programs and data. For the storage device 502, a ROM (Read Only Memory), a RAM (Random Access Memory), an HDD (Hard Disk Drive) and a flash memory can be given.

The 3D camera 214 images an object. An imaged image includes. two-dimensional RGB information and three-dimensional information which is information related to distance. When a normal camera is mounted, a distance sensor is separately provided so as to measure distance to an object to be picked (the article 203 to be picked and the housing 201). The driving circuit 504 drives and controls the robot arm 211 according to an instruction from the processor 501. The communication IF 505 transmits/receives data to/from a storage destination (the RFID tag 302, the server 400).

### <Picking Procedure Example of Picking Robot 210>

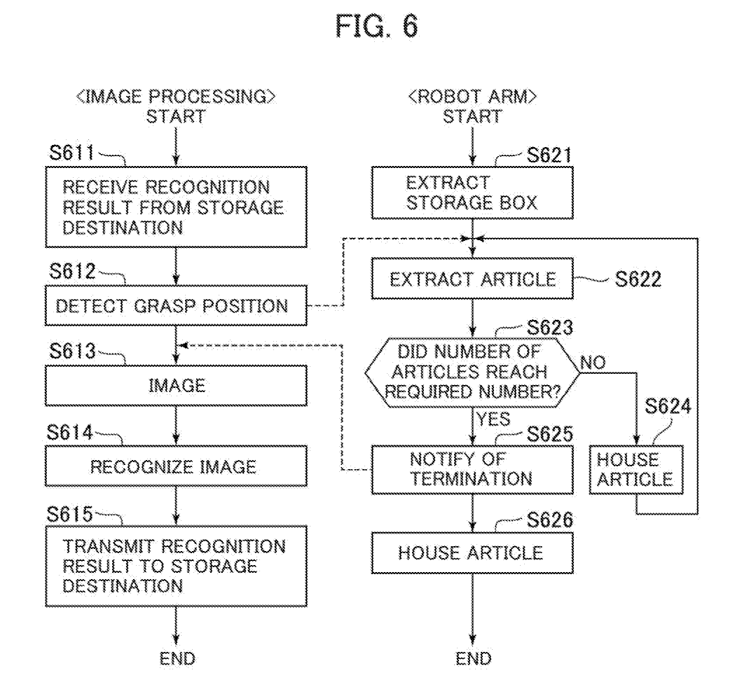

FIG. 6 is a flowchart showing a detailed picking procedure example 1 of the picking robot 210 in the first embodiment. The picking procedure example 1 is an example that the picking robot 210 recognizes an image. A storage destination of a recognition result may be the RFID tag 302 on the shelf 200 or the server 400. The left flowchart shows an image processing procedure example by the processor 501 and the right flowchart shows an operational procedure example of the robot arm 211 by the processor 501. The picking procedure example is executed in a case where the picking robot 210 accepts a picking request and the picking robot 210 is set in the vicinity of the shelf 200 which stores the housing 201 housing the article 203 included in the picking, request.

First, when the processor 501 accepts the picking request, it receives a recognition result from a storage destination (a step S611). In addition, when the processor 501 accepts the picking request, the left robot arm 211L extracts the housing 201 (a step S621). The processor 501 detects a grasp position of a picked number of articles 203 on the basis of the recognition result (a step S612). As the grasp position is detected (the step S612), the processor 501 instructs the right robot arm 211R to move to the grasp position and to extract the article 203 by grasping one (a step S622). When a number of extracted articles 203 does not reach the number to be picked (a step S623: No), the processor 501 instructs the right robot arm 211R to move and to house the grasped article 203 in the carry-out box 205 (a step S624), and the processor returns control to the step S622.

In the meantime, in the step S623, when the number of extracted articles 203 reaches the number to be picked (the step S623: Yes), the processor 501 transmits termination notice to image processing equipment (a step 625) and the processor 501 instructs the 3D camera 214 to image the housing 201 opposite to the opening (a step S613). Hereby, an imaged image from the opening of the housing 201 is acquired. Afterward, the processor 501 recognizes the imaged image (a step S614) and transmits a recognition result to the storage destination (a step S615).

As described above, in the in-warehouse work, as an image of the housing 201 where the corresponding article 203 to be picked is stored is recognized before the article 203 to be picked is specified, the article 203 to be picked can be extracted without executing recognition processing after the article 203 to be picked is specified. Accordingly, operation time can be reduced. In other words, operation time can be effectively utilized by executing recognition processing related to the corresponding housing 201 after extracting the article 203 to be picked before specifying the next article 203 to be picked in the housing 201, and work efficiency can be enhanced.

In addition, a recognition result from the picking robot 210 close to the shelf 200 that stores the housing 201 housing the article 203 to be picked can be stored by providing the RFID tag 302 to the shelf 200 for the storage destination of the recognition result. If only the storage destination is a record medium communicable at short distance, it is not limited to the RFID tag 302.

In FIG. 6, in the step S612, the grasp position of the articles 203 of the number to be picked is collectively detected; however, after extracting the article (the step S622), the processor 501 may also detect a grasp position related to one article 203 to be next picked (the step S612). In this case, the processor 501 transmits a grasp position detection request to the image processing equipment, and when the processor 501 receives the grasp position detection request in image processing, it excludes the already extracted articles 203 from the recognition result and detects a grasp position of the article 203 to be picked this time (the step S612). Hereby, the precision of detecting a grasp position can be enhanced.

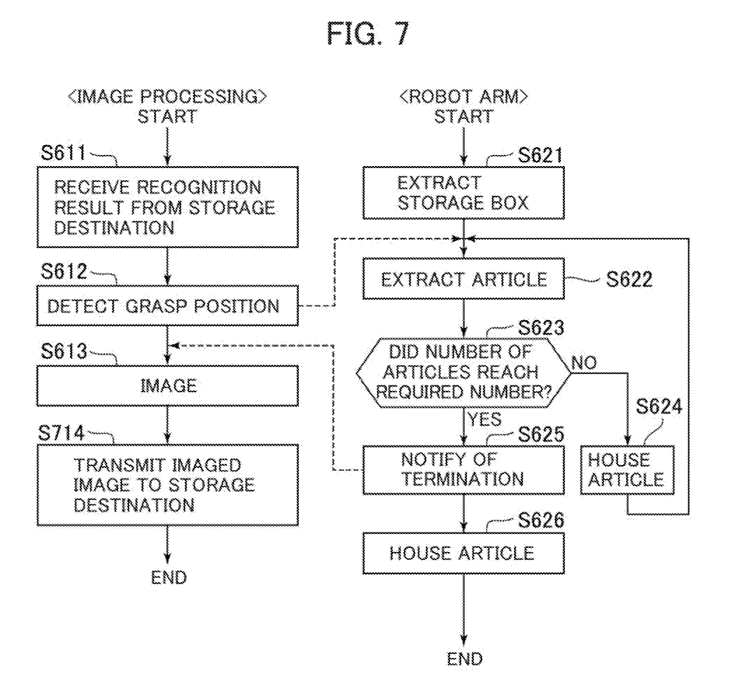

FIG. 7 is a flowchart showing a detailed picking procedure example 2 of the picking robot 210 in the embodiment. The picking procedure example 2 is an example that the server 400 executes image recognition. The same step number is allocated to the same processing contents as those in FIG. 6 and its description is omitted. In FIG. 7, in image processing, the processor 501 transmits an imaged image to the server 400 which is a storage destination after imaging (the step S613) (a step S714). The server 400 recognizes the received imaged image and stores a recognition result. Hereby, afterward, the picking robot 210 can receive the recognition result of the housing 201 from the server 400 (the step S611).

The recognition result can be collectively managed by providing the server 400 communicable with the picking robot 210 for the storage destination of the recognition result. In addition, a load and a cost of the picking robot 210 can be reduced by making the server 400 assume recognition processing.

### <Shipping Work Example 2>

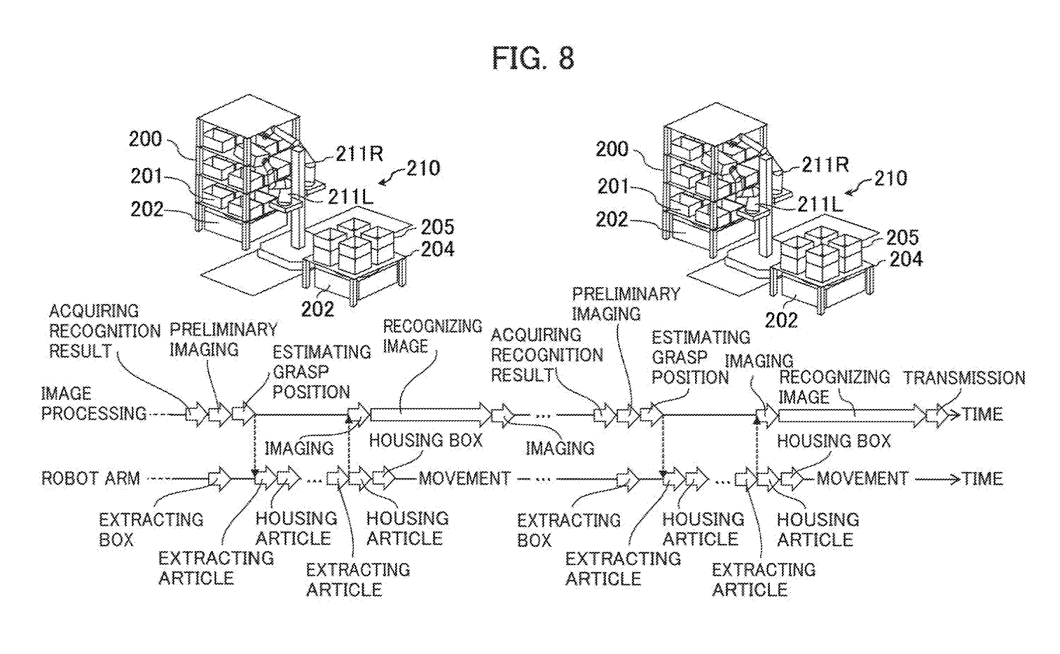

FIG. 8 is an illustration showing a shipping work example 2 in the first embodiment. The shipping work example 2 is a shipping work example that in extracting an article, a grasp position is estimated by the robot arm. A set position of the article 203 housed in the housing 201 may be displaced because of the extraction of the housing 201 and movement of the shelf 200. Hereby, displacement is made between a grasp position acquired from a recognition result and the actual set position of the article 203. Accordingly, the processor 501 acquires a recognition result in image processing (acquisition of the recognition result), instructs the 3D camera 214 to image the housing 201 opposite to the opening before extraction of the article (preliminary imaging), and the processor estimates a grasp position during extracting the article 203 using a preliminarily imaged image and the recognition result (an estimate of the grasp position).

Concretely, for example, the processor 501 calculates difference (displacement) between a position acquired from the recognition result and a position acquired from the preliminarily imaged image as to the article 203 to be picked. The processor 501 estimates a grasp position by modifying the grasp position acquired from the recognition result of the article 203 to be picked according to the difference.

More concretely, for example, when plural articles 203 overlapped with the article 203 to be picked which is acquired from the recognition result exist in a state that the recognition result and the preliminarily imaged image are overlapped, the processor 501 determines the article 203 having the largest overlapping area on the preliminarily imaged image as the article 203 to be picked and calculates a grasp position of the article 203 on the preliminarily imaged image. Concretely, for example, the processor 501 calculates a central position of a face of the article 203 to be picked as a grasp position. Hereby, the grasp position is estimated.

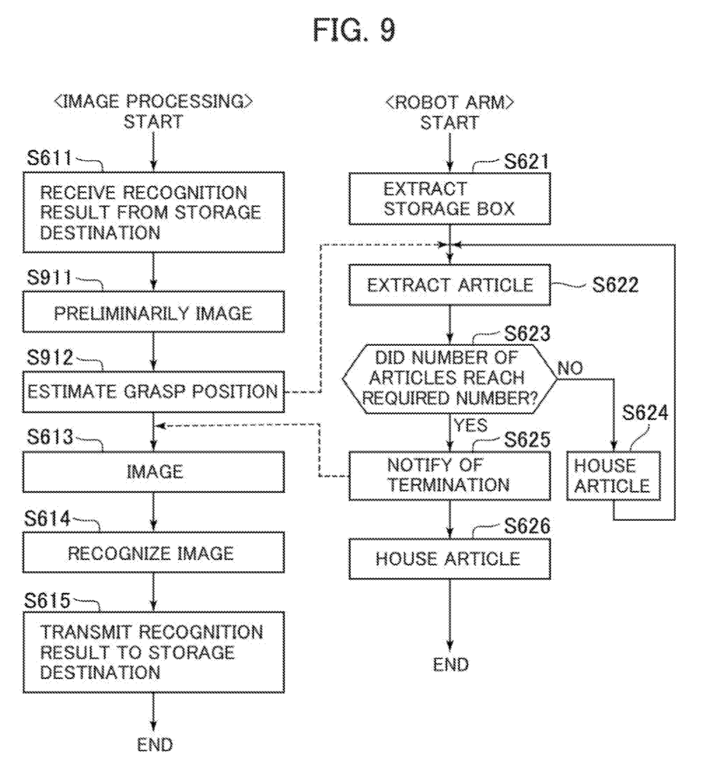

FIG. 9 is a flowchart showing a detailed picking procedure example 3 of the picking robot 210 in the first embodiment. The picking procedure example 3 is a picking work example related to the shipping work example 2 shown in FIG. 8. The same step number is allocated to the same processing contents as those in FIGS. 6 and 7 and its description is omitted. After receiving the recognition result (the step S611), the processor 501 instructs the 3D camera 214 to preliminarily image the housing 201 opposite to the opening (a step S911) and estimates a grasp position of the article 203 to be picked using the recognition result acquired in the step S611 and an image preliminarily imaged in the step S911 (a step S912). In this case, the right robot arm 211R extracts the article 203 by moving to the estimated grasp position which is an estimate result in the step S912 and grasping one (the step S622).

Displacement of the article 203 in the housing 201 is modified by preliminarily imaging the housing 201 immediately before extracting the article 203 to be picked, comparing the preliminarily imaged image with the recognition result and estimating the grasp position, and a success rate of grasping the article 203 to be picked can be enhanced.

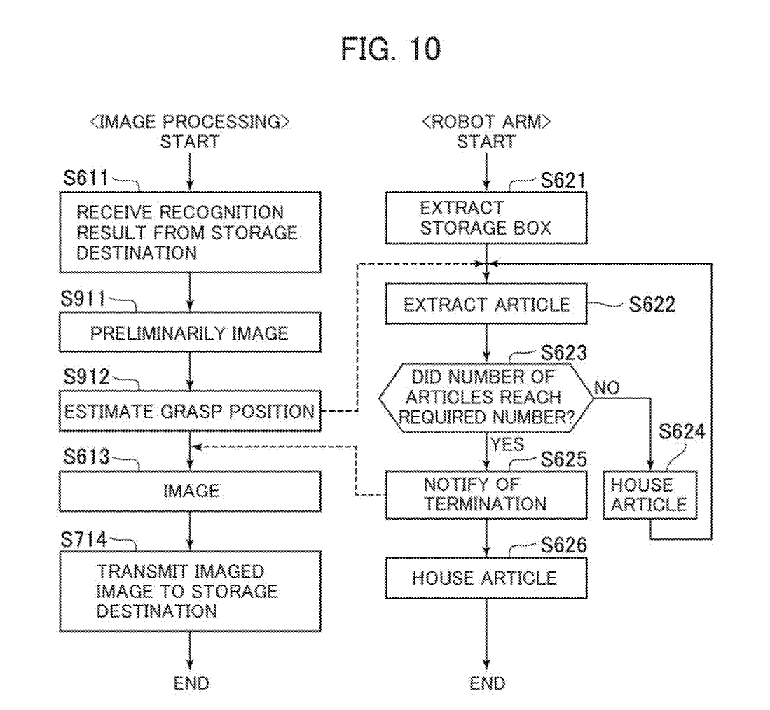

FIG. 10 is a flowchart showing a detailed picking procedure example 4 of the picking robot 210 in the first embodiment. The picking procedure example 4 is an example that image recognition is executed in the server 400 which is the storage destination in the picking procedure example 3. Accordingly, after imaging (the step S613), the processor 501 transmits an imaged image to the server 400 which is the storage destination (the step S714). The server 400 recognizes the received imaged image and stores a recognition result. Hereby, afterward, the picking robot 210 can receive the recognition result of the housing 201 from the server 400 (the step S611).

The recognition result can be collectively managed by providing the server 400 communicable with the picking robot 210 as a storage destination of the recognition result. In addition, the load and the cost of the picking robot 210 can be reduced by making the server 400 assume recognition processing.

### Second Embodiment

A second embodiment is an example of a case where in-warehouse work is warehousing as shown in FIG. 1. In the second embodiment, difference with the first embodiment will be mainly described. Accordingly, the same reference numeral is allocated to the same configuration and its description is omitted. The configurational examples shown in FIGS. 2 to 5 are similar in a picking robot 210 in the second embodiment.

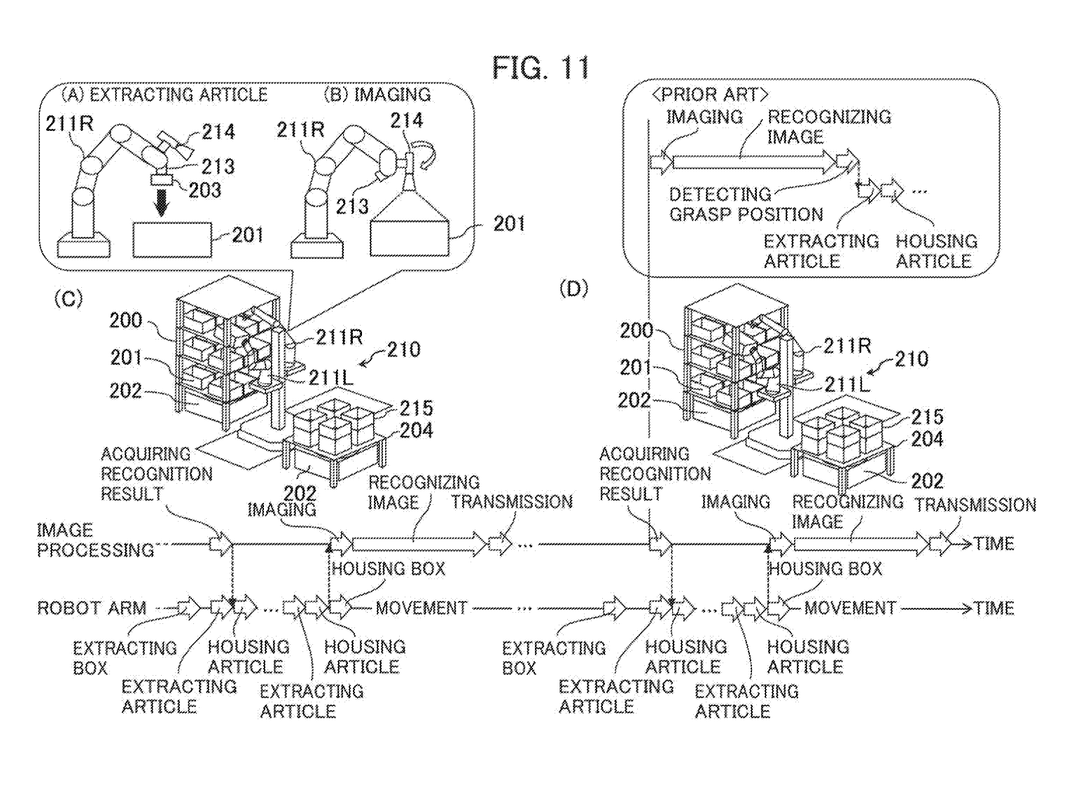

FIG. 11 is an illustration showing a warehousing work example 1 in the second embodiment. The picking robot 210 extracts a housing from a shelf 200, holding the housing 201 with one, for example, a left robot arm 211L and houses an article 203 in the housing 201 with the other, for example, a right robot arm 211R. The right robot arm 211R separately extracts the article 203 from a carry-in box 215 on a workbench 204 and houses it in the housing 201 on the shelf 200.

Concretely, for example, (A) after the right robot arm 211R houses the article 203 in the housing 201, (B) the right robot arm 211R instructs a 3D camera 214 to direct its lens to an opening of the housing 201 and to image the housing 201 opposite to the opening.

A process by the picking robot 210 will be described on a time base in a state in which the process is separated into image processing by a processor 501 and robot arm operation below. As shown in FIG. 11(C), first, when the processor 501 accepts a housing request, the left robot arm 211L extracts the housing 201 from the shelf 200 and the right robot arm 211R extracts an article 203 to be housed from the carry-in box 215.

The housing request includes identification information of the merchandise to be housed, a housed number, identification information of the shelf to store the housing and identification information of the housing 201 to store the merchandise. Concretely, for example, the processor 501 instructs the left robot arm 211L to extract the housing 201 from the shelf 200 by specifying a storage position of the housing 201 on the shelf 200 and a grasp position on the basis of the side opposite to the picking robot 210 of the housing 201, calculating an orbit from an initial position of the left robot arm 211L to the grasp position and controlling a driving shaft of each joint of the left robot arm 211L to enable reaching the orbit.

In addition, the processor 501 instructs the right robot arm 211R to extract the article 203 from the carry-in box 215 by specifying a position of the carry-in box 215, calculating an orbit from an initial position of the right robot arm 211R to a position of the carry-in box 215 and controlling a driving shaft of each joint of the right robot arm 211R to enable reaching the orbit.

The processor 501 acquires a recognition result of an image opposite to an opening of the housing 201 from a storage destination of the recognition result in image processing. The recognition result is equivalent to a recognition result processed before this extraction of the housing 201. Owing to the recognition result, the processor 501 can recognize in which position of the housing 201 a space area exists.

When the processor 501 acquires the recognition result, the right robot arm 211R houses one article 203 in the housing 201 using the recognition result (housing one article). Concretely, for example, the processor 501 instructs the right robot arm 211R to house the grasped article 203 in a housed position by specifying the housed position of the article 203 to be housed on the basis of the recognition result, calculating the orbit from the initial position of the right robot arm 211R to the housed position and controlling the driving shaft of each joint of the right robot arm 211R to enable reaching the orbit, and the processor instructs the right robot arm 211R to return to the initial position.

The right robot arm 211R repeatedly executes extracting and housing the article by the number specified in the housing request. When the right robot arm 211R houses the article 203 last specified out of the corresponding number in the housing 201, contents of the corresponding housing 201, that is, residual articles 203 and their arrangement are unchanged until picking according to the next picking request or housing according to the next housing request is performed.

Accordingly, in image processing, the processor 501 instructs the 3D camera 214 to image the housing 201 opposite to its opening as shown in (B), executes recognition processing of an imaged image, and the processor transmits a recognition result to a storage destination. The recognition processing may be concretely well-known recognition processing, for example, the processor 501 stores a contour and texture of the article 203 and character information such as an article name, and the processor recognizes the article 203 and its layout position by matching with the imaged image.

In addition, the left robot arm 211L houses the housing 201 on the shelf 200. Afterward, the picking robot 210 moves to another location, executing image recognition. Afterward, when a processor 501 of another picking robot 210 accepts a housing request for the same housing 201 on the same shelf 200 as those in (C) in (D) shown in FIG. 11, a left robot arm 211L extracts the housing 201 from the shelf 200 and a right robot arm 211R extracts an article 203 to be housed from the carry-in box 215. The following processing is the similar to that in (C).

As described above, as the last recognition result in picking or housing is read and a space area in the housing 201 is detected when the picking robot 210 houses the article 203, execution of image recognition before housing the article in this housing is not required and work efficiency can be enhanced.

### <Housing Procedure Example of Picking Robot 210>

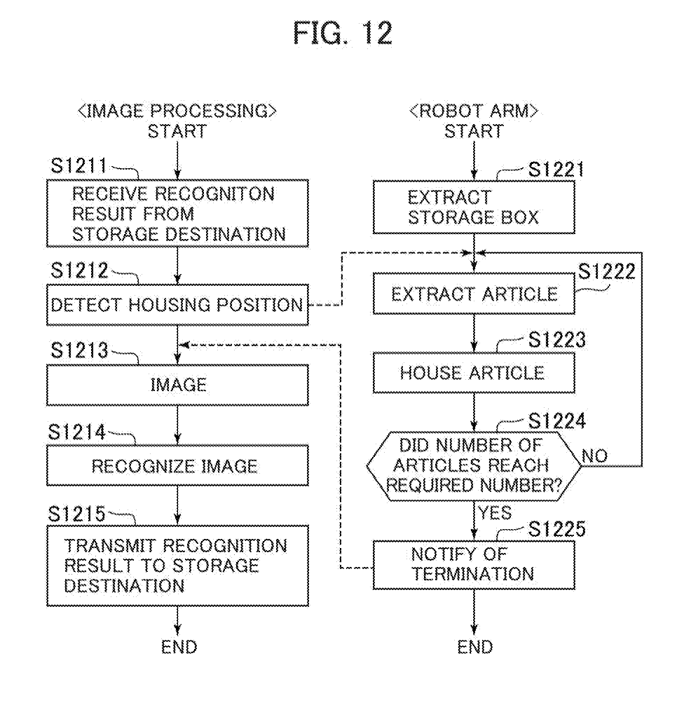

FIG. 12 is a flowchart showing a detailed housing procedure example 1 of the picking machine 210 in the embodiment. The housing procedure example 1 is equivalent to an example that the picking robot 210 recognizes an image. A storage destination of a recognition result may be an RFID tag 302 on the shelf 200 and a server 400. A left flowchart shows an image processing procedure example by the processor 501 and a right flowchart shows a robot arm operation procedure example by the processor 501. The housing procedure example is executed in a case where the picking robot 210 accepts a housing request and is arranged in the vicinity of the shelf 200 that stores the housing 201 housing the article 203 included in the housing request.

First, when the processor 501 accepts a housing request, it receives a recognition result from a storage destination (a step S1211). In addition, when the processor 501 accepts the housing request, the left robot arm 211L extracts the housing 201 (a step S1221). The processor 501 detects a position to house articles 203 of a number to be housed (a space area) on the basis of the recognition result (a step S1212). When the housed position is detected (the step S1212), the processor 501 instructs the right robot arm 211R to move, to extract the article 203 from the carry-in box 215 by grasping one (a step S1222) and to house the extracted article 203 in the housed position detected in the step S1212 of the housing 201 extracted in the step S1221 (a step S1223). When the number of housed articles 203 does not reach the number to be housed (a step S1224: No), the processor 501 instructs the right robot arm 211R to return the initial position and returns control to the step S1222.

In the meantime, when the number of housed articles 203 reaches the number to be housed in the step S1224 (the step S1224: Yes), the processor 501 transmits termination notice to image processing equipment (a step S1225) and the processor 501 instructs the 3D camera 214 to image the housing 201 opposite to the opening (the step S1213). Hereby, an image imaged opposite to the opening of the housing 201 is acquired. Afterward, the processor 501 recognizes the imaged image (the step S1214) and transmits a recognition result to the storage destination (the step S1215).

As described above, in in-warehouse work, as the image of the housing 201 for housing the article 203 to be housed is recognized before specifying the article 203 to be housed, the article 203 to be housed can be housed without executing recognition processing after specifying the article 203 to be housed. Accordingly, operation time can be reduced. In other words, operation time can be effectively utilized by executing recognition processing of the housing 201 after the article 203 to be housed is housed before specifying an article 203 to be housed in the corresponding housing 201 in the next housing request, and work efficiency can be enhanced.

In addition, a recognition result from the picking robot 210 close to the shelf 200 that stores the housing 201 to house the article 203 to be housed can be stored by providing the RFID tag 302 to the shelf 200 as a storage destination of the recognition result. If only the storage destination is a close-range communicable record medium, it is not limited to the RFID tag 302.

In FIG. 12, in the step S1212, the housed position of the articles 203 of the housed number is collectively detected, however, after housing the article (the step S1223), the processor 501 may also detect a housed position of one article 203 to be housed next (the step S1212). In this case, the processor 501 transmits a housed position detection request to the image processing equipment, when the processor 501 receives the housed position detection request in image processing, it excludes the housed positions of the already housed articles 203 from the recognition result and detects a housed position of the article 203 to be housed this time (the step S1212). Hereby, the precision of detecting the housed position can be enhanced.

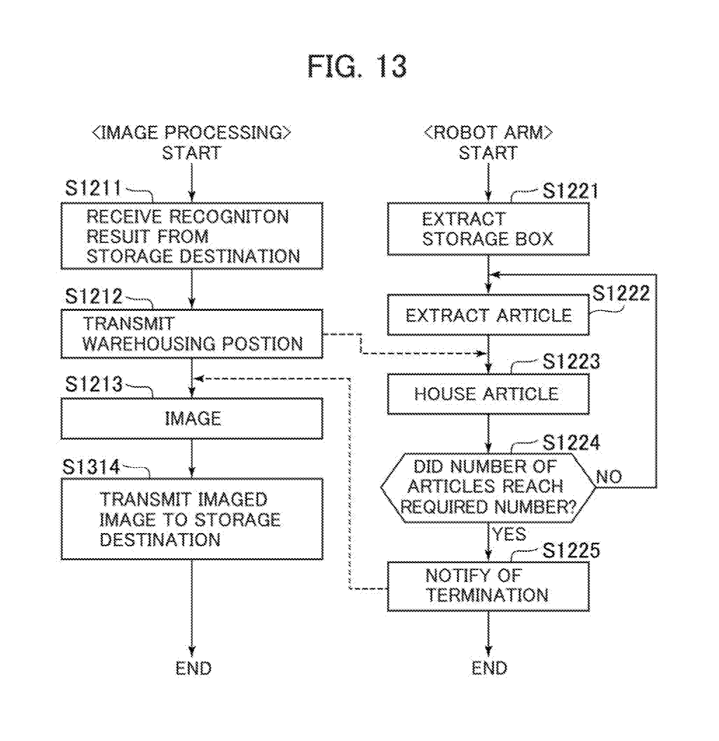

FIG. 13 is a flowchart showing a detailed housing procedure example 2 of the picking robot 210 in the second embodiment. The housing procedure example 2 is equivalent to an example that the server 400 executes image recognition. The same step number is allocated to the same processing contents as those in FIG. 12 and its description is omitted. In FIG. 13, in image processing, the processor 501 transmits an imaged image to the server 400 which is a storage destination after imaging (the step S1213) (a step S1314). The server 400 recognizes the received imaged image and stores a recognition result. Hereby, afterward, the picking robot 210 can receive the recognition result of the corresponding housing 201 from the server 400 (the step S1211).

The recognition result can be collectively managed by providing the server 400 communicable with the picking robot 210 as a storage destination of the recognition result. In addition, a load and a cost of the picking robot 210 can be reduced by making the server 400 assume recognition processing.

### <Warehousing Work Example 2>

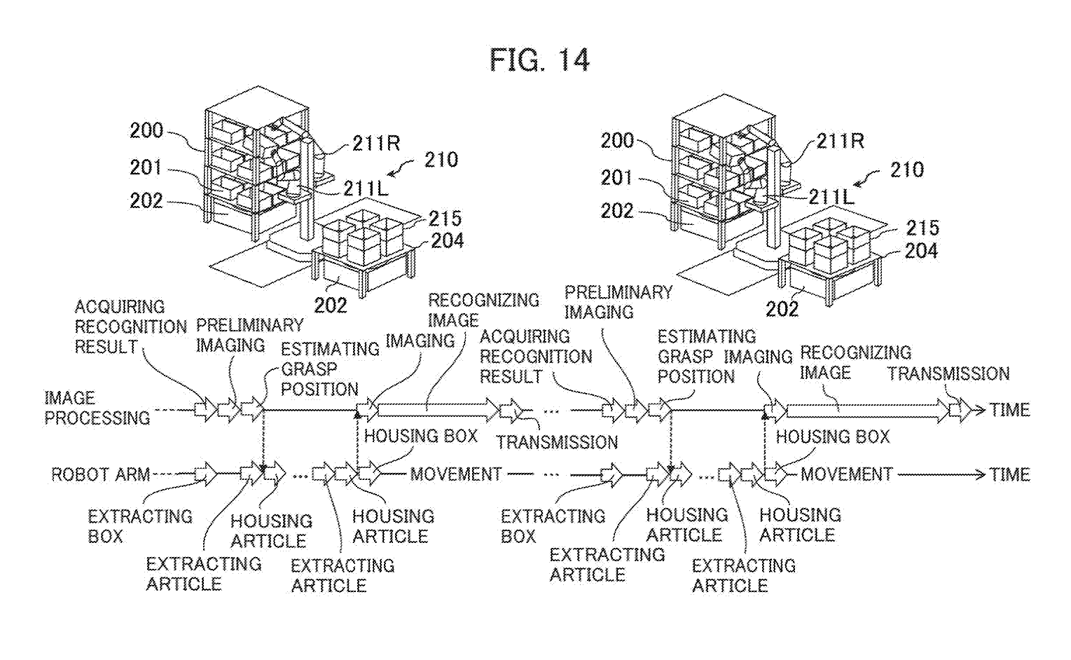

FIG. 14 is an illustration showing a warehousing work example 2 in the second embodiment. The warehousing work example 2 is equivalent to a warehousing work example that a position housed by the robot arm is estimated in housing an article. A set position of the article 203 housed in the housing 201 may be displaced because of the extraction of the housing 201 and movement of the shelf 200. Hereby, displacement is made between a housed position acquired from a recognition result and the actual set position of the article 203. Accordingly, the processor 501 acquires the recognition result in image processing (acquiring the recognition result), instructs the 3D camera 214 to preliminarily image the housing 201 opposite to the opening before housing the article (preliminary imaging), and the processor estimates the housed position during extracting the article 203 using the preliminarily imaged image and the recognition result (estimating the housed position).

Concretely, for example, the processor 501 calculates difference (displacement) between a position acquired from the recognition result and a position acquired from the preliminarily imaged image as to the article 203 to be housed. The processor 501 estimates a housed position by modifying the housed position acquired from the recognition result of the article 203 to be housed according to the difference.

More concretely, when the recognition result and the preliminarily imaged image are overlapped for example and the article 203 overlapped with the housed position acquired from the recognition result exists, the processor 501 selects another housed position acquired from the recognition result until no overlapped article 203 exists. Hereby, the housed position is estimated.

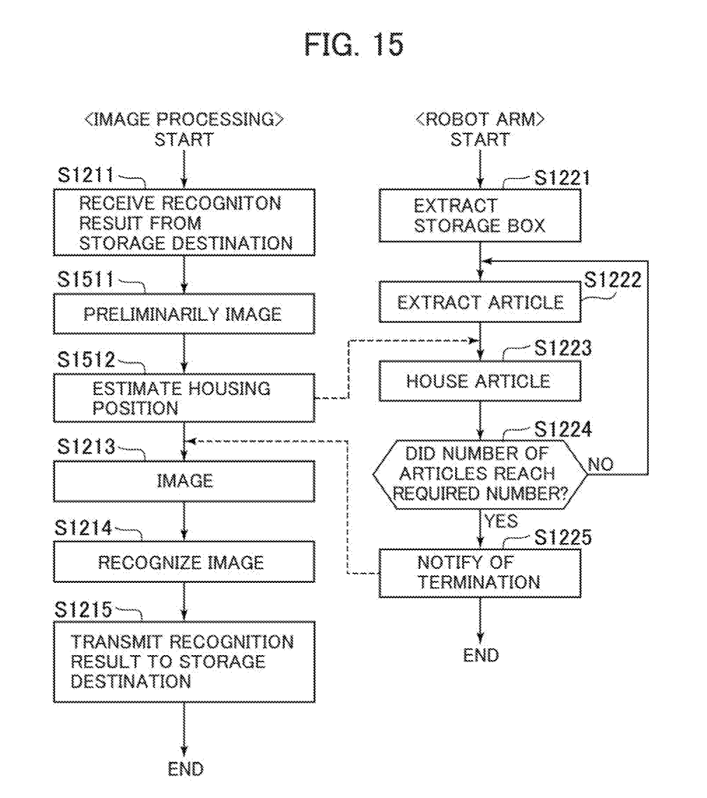

FIG. 15 is a flowchart showing a detailed housing procedure example 3 of the picking robot 210 in the second embodiment. The housing procedure example 3 is equivalent to a picking work example in the warehousing work example 2 shown in FIG. 14. The same step number is allocated to the same processing contents as those in FIGS. 12 and 13 and its description is omitted. After receiving the recognition result (the step S1211), the processor 501 instructs the 3D camera 214 to preliminarily image the housing 201 opposite to the opening (a step S1511) and estimates a housed position of the article 203 to be housed using the recognition result acquired in the step S1211 and the image imaged in the step S1511 (a step S1512). In this case, the right robot arm 211R is moved to an estimated housed position which is an estimate result in the step S1512 and the article 203 extracted from the carry-in box 215 in the step S1222 is housed in the estimated housed position (the step S1223).

Displacement of the articles 203 in the housing 201 is modified by preliminarily imaging the housing 201 immediately before housing the article 203 to be housed, comparing the preliminarily imaged image and the recognition result with estimating the housed position, and a success rate in housing the article 203 to be housed can be enhanced.

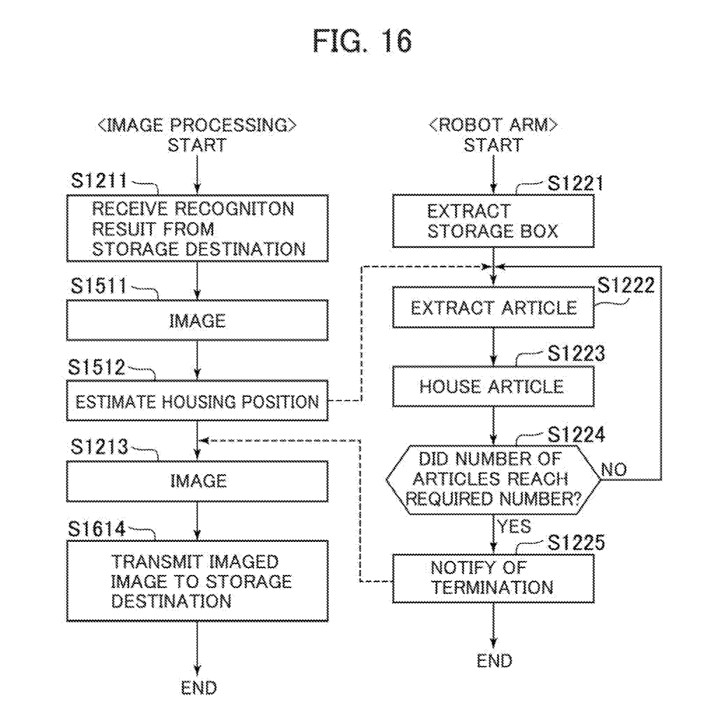

FIG. 16 is a flowchart showing a detailed housing procedure example 4 of the picking robot 210 in the second embodiment. The housing procedure example 4 is equivalent to an example that image recognition is executed in the server 400 which is the storage destination in the housing procedure example 3. Accordingly, after imaging (the step S1213), the processor 501 transmits an imaged image to the server 400 which is the storage destination (a step S1614). The server 400 recognizes the received imaged image and stores a recognition result. Hereby, afterward, the picking robot 210 can receive the recognition result of the housing 201 from the server 400 (the step S1211).

The recognition result can be collectively managed by providing the server 400 communicable with the picking robot 210 as the storage destination of the recognition result. In addition, the load and the cost of the picking robot 210 can be reduced by making recognition processing assume the server 400.

As described above, the abovementioned picking robot 210 is provided with the processor 501 that executes a program, a storage device 502 that stores the program, an imaging device that images an object (for example, the 3D camera 214) and the robot arm (211L, 211R) that accesses a housed area of the article 203 (for example, the housing 201). The processor 501 executes an acquisition process for acquiring the latest recognition result from a storage destination of the latest recognition result of the housed area on the basis of the latest imaged image of the housed area, a modification process for accessing the housed area and modifying a location in the housed area by controlling the robot arm on the basis of the latest recognition result acquired in the acquisition process, an imaging process for imaging the housed area after modification in the housed area by the modification process by controlling the imaging device, a recognition process for recognizing residual articles in the housed area on the basis of an image imaged in the imaging process, and a transmission process for transmitting a recognition result by the recognition process to the storage destination.

Hereby, a picking robot B that first accesses the same shelf afterward acquires a recognition result on the basis of an image imaged by a picking robot A that last accesses the shelf for shipping or warehousing. After shipping or warehousing work, a recognition result on the basis of an imaged image of the housing after the work is generated and stored. Accordingly, time of the recognition process of the image which requires the most time in a series of work can be covered and work efficiency can be enhanced.

In addition, the picking robot 210 is provided with the processor 501 that executes a program, a storage device 502 that stores the program, an imaging device that images an object (for example, the 3D camera 214) and the robot arm (211L, 211R) that accesses a housed area (for example, the housing 201) of the article 203. The processor 501 executes an acquisition process for acquiring the latest recognition result in a recognition process from the server 400 that executes the recognition process for recognizing an article in the housed area on the basis of the latest imaged image of the housed area, a modification process for accessing the housed area and modifying a location in the housed area by controlling the robot arm according to the latest recognition result acquired as a result of the acquisition process, an imaging process for imaging the housed area after modification in the housed area by the modification process by controlling the imaging device, and a transmission process for transmitting an image imaged in the imaging process to the server 400.

Hereby, the picking robot B that first accesses the same shelf afterward acquires a recognition result on the basis of an image imaged by the picking robot A that last accesses the shelf for shipping or warehousing. After shipping or warehousing work, the picking robot B transmits an imaged image of the housing after the work to the server 400. In this case, after the work, the server 400 generates and stores a recognition result on the basis of the imaged image. Accordingly, time for recognizing the image which requires the most time in a series of work can be covered and work efficiency can be enhanced.

Moreover, in the picking robot 210, in the transmission process, the processor 501 may also transmit the recognition result to a communicable record medium (for example, the RFID tag 302) provided to the shelf 200 that stores the housed area as a storage destination and in the acquisition process, the processor 501 may also acquire the latest recognition result recorded in the record medium from the record medium.

As described above, the recognition result from the picking robot 210 accessing the shelf 200 that stores the housing 201 housing the article 203 to be picked can be stored by simple configuration such as providing the RFID tag 302 to the shelf 200 as a storage destination of a recognition result.

In addition, in the picking robot 210, in the transmission process, the processor 501 may also transmit the recognition result to the server 400 communicable with the picking robot 210 as a storage destination and in the acquisition process, the processor 501 may also acquire the latest recognition result stored in the server 400 from the server 400.

As described above, the recognition result can be collectively managed by providing the server 400 communicable with the picking robot 210 as a storage destination of a recognition result. In addition, the load and the cost of the picking robot 210 can be reduced by making the server 400 assume the recognition process.

Further, in the picking robot 210, the processor 501 controls the imaging device so as to execute a preliminary imaging process for imaging the housed area before modification in the housed area by the modification process and an estimate process for estimating a position in the housed area for the robot arm to access (a position of an article to be grasped or a position to be housed of a grasped article) on the basis of the latest recognition result acquired in the acquisition process and the preliminary imaged image by the preliminary imaging process, and in the modification process, the processor 501 controls the robot arm on the basis of an estimate result by the estimate process so as to access the housed area and modify a location in the housed area.

As described above, displacement in the position of the article 203 in the housed area is modified by preliminarily imaging the housed area, comparing the preliminary imaged image with the recognition result and estimating a housed position and a success rate as to modification in the housed area by the access to the housed area can be enhanced.

Furthermore, in the modification process, as described in the first embodiment, the processor 501 controls the robot arm on the basis of the latest recognition result acquired in the acquisition process so as to extract the article from the housed area. Hereby, the recognition process related to the inside of the housed area can be executed after extraction in the shipping work (or housing in the warehousing work) and before extraction in the next shipping work, the recognition process is covered, and the efficiency of the shipping work can be enhanced.

Furthermore, in the modification process, as described in the second embodiment, the processor 501 controls the robot arm on the basis of the latest recognition result acquired in the acquisition process so as to house the article in the housed area. Hereby, the recognition process as to the housed area can be executed after housing in the warehousing work (extraction in the shipping work) and before housing in the next warehousing work, the recognition process is covered, and the efficiency of the shipping work can be enhanced.

In actual in-warehouse work, shipping work and warehousing work may be mixed, however, the shipping work in the first embodiment and the warehousing work in the second embodiment can be simultaneously realized in parallel. In this case, when a picking request for a certain housing 201 on a certain shelf 200 is received, a recognized image after extracting an article is stored in a storage destination and immediately after it, when a housing request for the same housing 201 is received, a housed position is detected or estimated using the immediately previous recognition result. Similarly, when a hosing request for a certain housing 201 on a certain shelf 200 is received, a recognized image after housing an article is stored in a storage destination and immediately after it, when a picking request for the same housing 201 is received, a grasped position is detected or estimated using the immediately previous recognition result.

The present invention is not limited to the abovementioned embodiments, and various variations and similar configurations in purport of attached claims are included. For example, the abovementioned embodiments are detailedly described to clearly explain the present invention and the present invention is not necessarily limited to all the described configurations. In addition, a part of the configuration in one embodiment may also be replaced with the configuration in another embodiment. Moreover, the configuration in another embodiment may also be added to the configuration in one embodiment.

Furthermore, another configuration may also be added, deleted or replaced to/from/with a part of the configuration in each embodiment.

Further, the abovementioned each configuration, functions, processors, processing means and others may also be realized by hardware by designing a part or the whole of them with an integrated circuit for example and may also be realized by software by making the processor interpret and execute a program for realizing respective functions.

Information such as a program for realizing each function, a table and a file can be stored in a storage such as a memory, a hard disk and a SSD (Solid State Drive) or a record medium such as an IC (Integrated Circuit) card, an SD card and a DVD (Digital Versatile Disc).

Furthermore, as for a control line and an information line, those considered necessary for explanation are shown, and all required control lines and information lines are actually not shown. Actually, it may be considered that most configurations are mutually connected.

What is claimed is:

1. A picking robot provided with a processor that executes a program, a storage device that stores the program, an imaging device that images an object, and a robot arm that accesses a housed area of an article,
wherein the processor executes:
an acquisition process for acquiring the latest recognition result from a storage destination of the latest recognition result of the housed area on the basis of the latest imaged image of the housed area;
a modification process for accessing the housed area and modifying a location in the housed area by controlling the robot arm on the basis of the latest recognition result acquired in the acquisition process;
an imaging process for imaging the housed area after modification in the housed area by the modification process by controlling the imaging device;
a recognition process for recognizing residual articles in the housed area on the basis of an image imaged in the imaging process; and
a transmission process for transmitting a recognition result by the recognition process to the storage destination.

2. A picking robot provided with a processor that executes a program, a storage device that stores the program, an imaging device that images an object, and a robot arm that accesses a housed area of an article,
wherein the processor executes:
an acquisition process for acquiring the latest recognition result in a recognition process from a server that executes the recognition process for recognizing the article in the housed area on the basis of the latest imaged image of the housed area;
a modification process for accessing the housed area and modifying a location in the housed area by controlling the robot arm according to the latest recognition result acquired in the acquisition process;
an imaging process for imaging the housed area after modification in the housed area by the modification process by controlling the imaging device; and
a transmission process for transmitting an image imaged in the imaging process to the server.

3. The picking robot according to claim 1,
wherein in the transmission process, the processor transmits the recognition result to a communicable record medium provided to a shelf for storing the housed area as the storage destination; and
in the acquisition process, the processor acquires the latest recognition result recorded in the record medium from the record medium.

4. The picking robot according to claim 1,
wherein in the transmission process, the processor transmits the recognition result to a server communicable with the picking robot as the storage destination; and
in the acquisition process, the processor acquires the latest recognition result stored in the server from the server.

5. The picking robot according to claim 1,
wherein the processor executes:
a preliminary imaging process for imaging the housed area before modification in the housed area by the modification process by controlling the imaging device; and
an estimate process for estimating a position for the robot arm to access in the housed area on the basis of the latest recognition result acquired in the acquisition process and an image preliminarily imaged in the preliminary imaging process; and
in the modification process, the processor controls the robot arm on the basis of an estimate result in the estimate process so as to access the housed area and modify a location in the housed area.

6. The picking robot according to claim 1,
wherein in the modification process, the processor controls the robot arm on the basis of the latest recognition result acquired in the acquisition process so as to extract the article from the housed area.

7. The picking robot according to claim 1,
wherein in the modification process, the processor controls the robot arm on the basis of the latest recognition result acquired in the acquisition process so as to house the article in the housed area.

8. A picking system provided with a picking robot and a shelf having a housed area of an article,
wherein the picking robot is provided with a processor that executes a program, a storage device that stores the program, an imaging device that images an object, and a robot arm that accesses the housed area;
the shelf is provided with a record medium that stores the latest recognition result of the housed area on the basis of the latest imaged image of the housed area and can communicate with the picking robot; and
the processor executes:
an acquisition process for acquiring the latest recognition result from the record medium;
a modification process for accessing the housed area and modifying a location in the housed area by controlling the robot arm on the basis of the latest recognition result acquired in the acquisition process;
an imaging process for imaging the housed area after modification in the housed area by the modification process by controlling the imaging device;
a recognition process for recognizing residual articles in the housed area on the basis of an image imaged in the imaging process; and
a transmission process for transmitting a recognition result in the recognition process to the record medium.

9. A picking system provided with a picking robot and a server communicable with the picking robot,
wherein the picking robot is provided with an imaging device that images an object, and a robot arm that accesses a housed area of an article and controls the imaging device and the robot arm;
the server executes a recognition process for recognizing the article in the housed area on the basis of the latest imaged image of the housed area; and
the picking robot executes:
an acquisition process for acquiring the latest recognition result in the recognition process from the server;
a modification process for accessing the housed area and modifying a location in the housed area by controlling the robot arm according to the latest recognition result acquired in the acquisition process;
an imaging process for imaging the housed area after modification in the housed area by the modification process by controlling the imaging device; and
a transmission process for transmitting an image imaged in the imaging process to the server.
